(19) United States
(12) Patent Application Publication
(10) Pub. No.: US 2003/0224891 A1
(43) Pub. Date: Dec. 4, 2003

(54) Chain casing for a bicycle

(76) Inventor: Joe Chou, Tai-Ping City (TW)

Correspondence Address: HARNESS, DICKEY & PIERCE, P.L.C., P.O. BOX 828, BLOOMFIELD HILLS, MI, 48303, US

(21) Appl. No.: 10/160,810

(22) Filed: May 31, 2002

(51) Int. Cl. F16D 1/00; B62J 13/00; F16H 57/02

(52) U.S. Cl. 474/146; 474/144; 474/147

(57) ABSTRACT

A chain casing of a bicycle includes an intermediate hollow body that extends between a chain ring and a sprocket. The hollow body has a peripheral wall defining a receiving space. First and second partitions extend in the receiving space to divide the same into upper and lower compartments that receive the upper and lower chain sections of a chain extending between the chain ring and the sprocket. A tension roller is disposed between a front end of the hollow body and the chain ring below the lower chain section, which is in sliding contact with and straddles the tensioning roller.

### BACKGROUND OF THE INVENTION

1. Field of the Invention

The invention relates to a chain casing, more particularly to a bicycle chain casing that includes a plurality of compartments for receiving a chain and cables of a bicycle.

2. Description of the Related Art

Referring to FIG. 1, a conventional bicycle 20 is shown to include a chain ring 21, a crank pedal 22 co-axially mounted to the chain ring 21, an axle 24 disposed rearwardly of the chain ring 21, a sprocket (not visible) mounted on the axle 24, a chain stay (not visible) extending from the chain ring 21 to the sprocket, a chain (not visible) trained on the sprocket and the chain ring 21, and a chain casing 23 fixed to the chain stay and extending between the sprocket and the chain ring 21 in such a manner as to enclose the chain ring 21, the sprocket and the chain.

One disadvantage of the aforesaid conventional bicycle resides in that the size of the chain casing is relatively large.

### SUMMARY OF THE INVENTION

The object of this invention is to provide a chain casing for a bicycle which can overcome the aforesaid drawback associated with the conventional bicycle.

Accordingly to one aspect of the present invention, a chain casing is adapted for use in a bicycle which includes a chain ring, a crank pedal co-axially connected to the chain ring, an axle disposed rearwardly of the chain ring, a sprocket mounted on the axle, a chain stay extending between the chain ring and the sprocket, and a chain trained on the chain ring and the sprocket, and having upper and lower chain sections. The chain casing includes an intermediate hollow body adapted to be fixed to the chain stay and adapted to extend between the chain ring and the sprocket. The intermediate hollow body has front and rear ends, a peripheral wall extending from the front end to the rear end and defining a receiving space, and a partition extending in the receiving space to divide the receiving space into upper and lower compartments that are adapted to respectively receive the upper and lower chain sections therein. A tensioning roller is disposed between the front end of the peripheral wall and the chain ring, and is adapted to be disposed below and in sliding contact with the lower claim section. The tensioning roller is straddled by the lower chain section of the chain.

Accordingly to another aspect of the present invention, the chain casing further includes a front shield portion detachably fastened to the intermediate hollow body and adapted to cover the chain ring in such a manner as to permit exposure of the crank pedal therefrom, and a rear shield portion detachably fastened to the intermediate hollow body and adapted to cover the sprocket in such a manner as to permit exposure of the axle therefrom.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional bicycle;

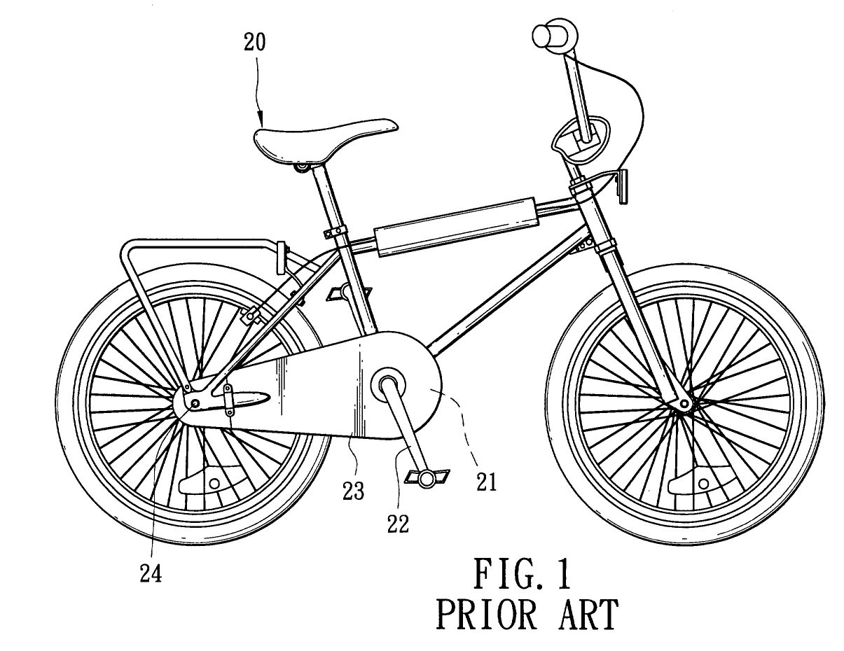

FIG. 2 is side view of a bicycle according to the present invention;

FIG. 3 is a fragmentary perspective view of the bicycle, in which, a chain casing is partly exploded to illustrate interior of the same;

FIG. 4 is a fragmentary rear view of the bicycle;

FIG. 5 is an exploded perspective view of the chain casing employed in the bicycle of the present invention;

FIG. 6 is a cross sectional view of the chain casing taken along lines VI-VI in FIG. 5;

FIG. 7 is a side view of a modified bicycle according to the present invention;

FIG. 8 is a fragmentary perspective view of the modified bicycle, in which, a chain casing is partly exploded to illustrate interior of the same;

FIG. 9 is an exploded perspective view of another chain casing adapted for use in the modified bicycle of the present invention; and

FIG. 10 is a sectional view of the chain casing shown in FIG. 9.

### DETAILED DESCRIPTION OF THE PREFERRED EMBODIMENTS

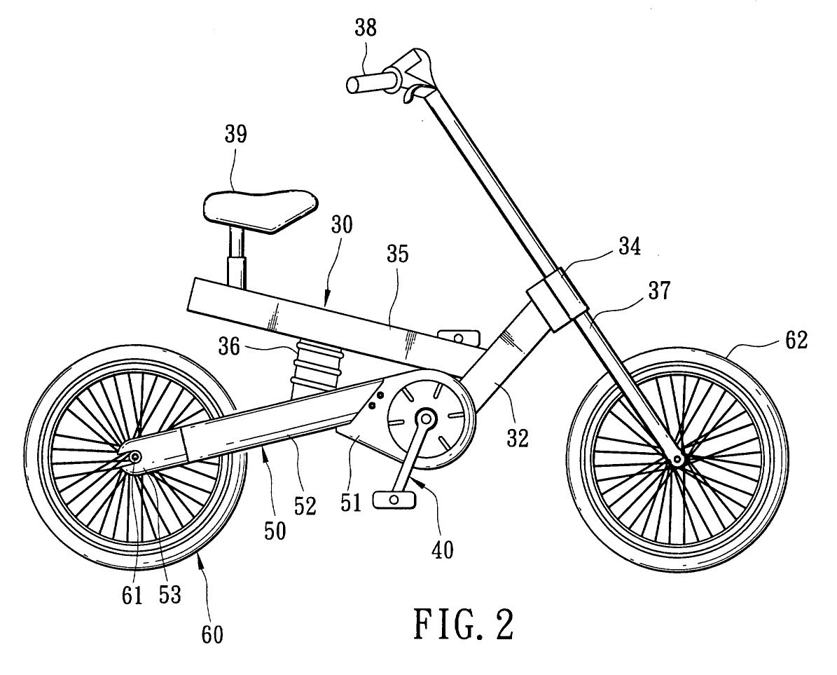

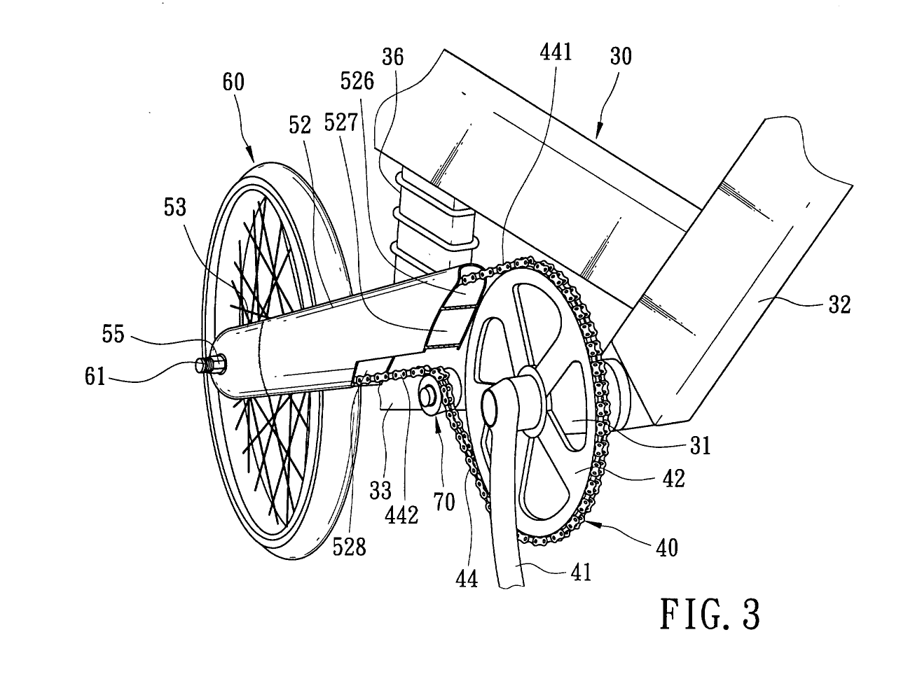

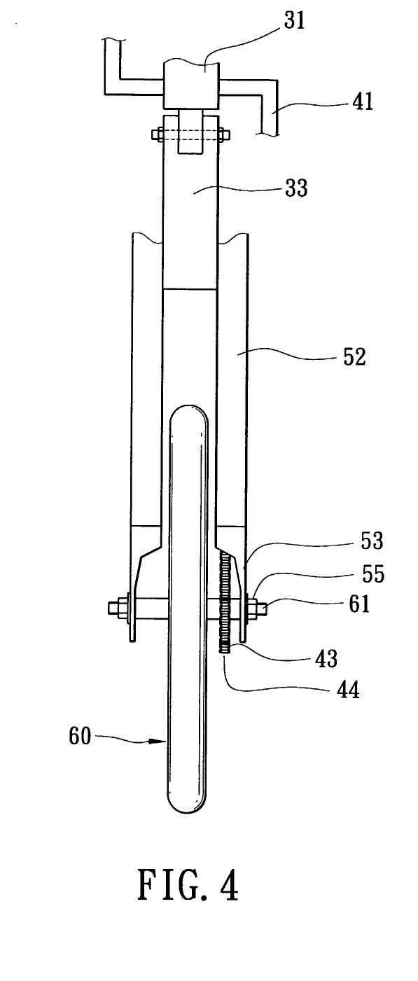

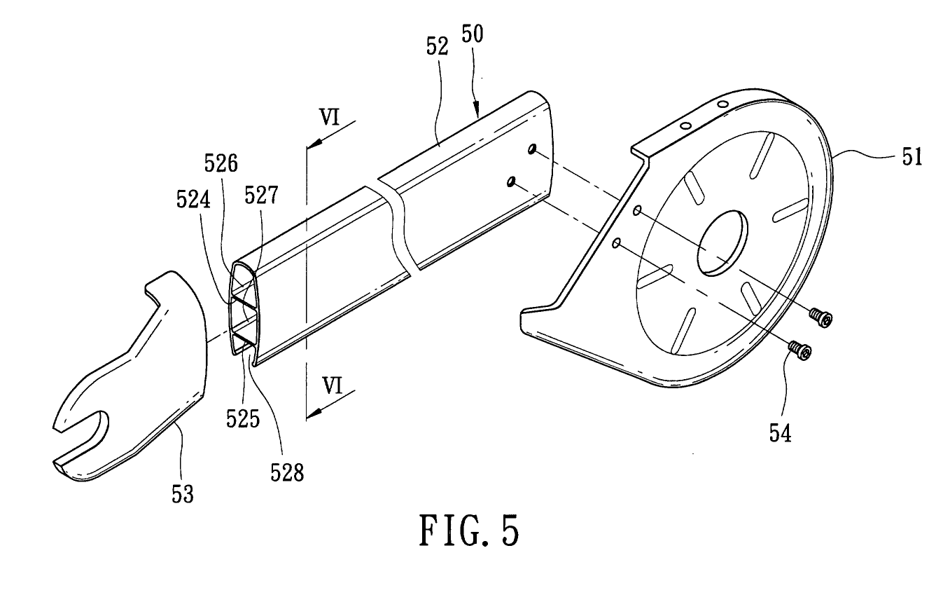

Referring to FIGS. 2 to 5, the preferred embodiment of a bicycle 30 of the present invention is shown to include a cross bar 35 having a front end connected to a down tube 32 and a rear end, a seat 39 disposed securely on the rear end of the cross bar 35, a head tube 34 having an upper end connected to a handle 38, a front fork 37 extending downwardly from a lower end of the head tube 34 to permit mounting of a front wheel 62 thereon, a crank unit 40 fixed to a lower end of the down tube 32 via a horizontal crank-mounting tube 31 and formed with a chain ring 42, a crank pedal 41 co-axially connected to the chain ring 42, an axle 61 disposed rearwardly of the chain ring 42, a sprocket 43 mounted on the axle 61, a chain stay 33 extending between the chain ring 42 and the sprocket 43, and a chain 44 trained on the chain ring 42 and the sprocket 43 and having upper and lower chain sections 441, 442. A shock absorbing unit 36 is disposed between and interconnects the cross bar 35 and the chain stay 33. A rear wheel 60 is rotatably mounted on the axle 61, and is operably fastened to the sprocket 43 in such a manner that the sprocket 43 co-rotates with the chain ring 42 when the crank pedal 41 is pedaled in a forward direction.

A chain casing 50 of the present invention includes a front shield portion 51, a rear shield portion 53, and an intermediate hollow body 52. The intermediate hollow body 52 is fixed to the chain stay 33, and extends between the chain ring 42 and the sprocket 43. The hollow body 52 has front and rear ends, a peripheral wall extending from the front end to the rear ends and defining a receiving space, and first and second partitions 524, 525 extending in the receiving space to divide the receiving space into upper and lower compartments 526, 528 that receive the upper and lower chain sections 441, 442, respectively, and an intermediate compartment 527 between the upper and lower compartments 526, 528. A tensioning wheel 70 is disposed between the front end of the intermediate hollow body 52 and the chain ring 42, and is disposed below and is in sliding contact with the lower chain section 442 of the chain 44. The lower chain section 442 straddles the tensioning wheel 70 and then turns downward to contact the chain ring 42.

The front shield portion 51 is detachably fastened to the intermediate hollow body 52 via screws 54, and covers the chain ring 42 in such a manner as to permit exposure of the crank pedal 41 therefrom. The rear shield portion 53 is detachably fastened to the intermediate hollow body 52, and is mounted on the axle 61 via a fastener nut 55 so as cover the sprocket 43 in such a manner to permit exposure of the axle 61 therefrom. The intermediate compartment 527 is disposed to receive cables, such as brake cables and gear cables (not shown).

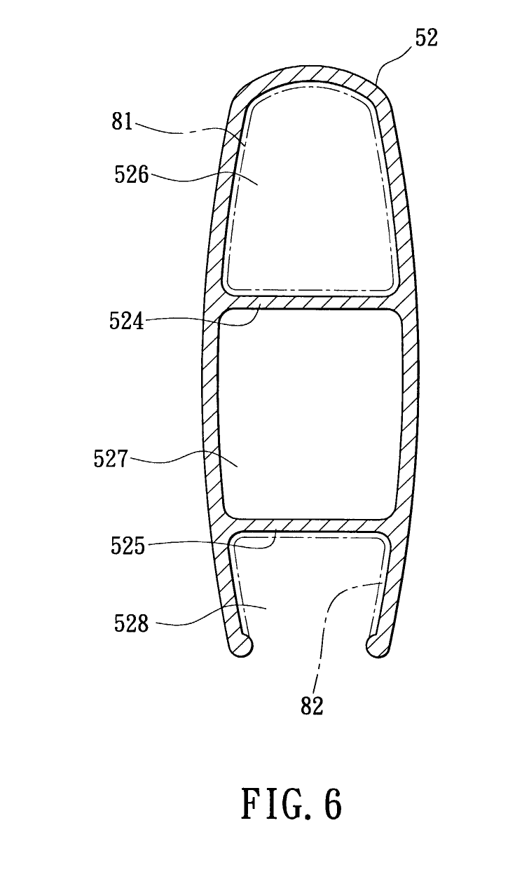

Preferably, first and second sound-absorbing members 81, 82 are mounted respectively in the upper and lower compartments 526, 528 (see FIG. 6) around the upper chain section 441 and the lower chain section 442 of the chain 44 so as to absorb vibrating sound resulting from rotation of the chain ring 42.

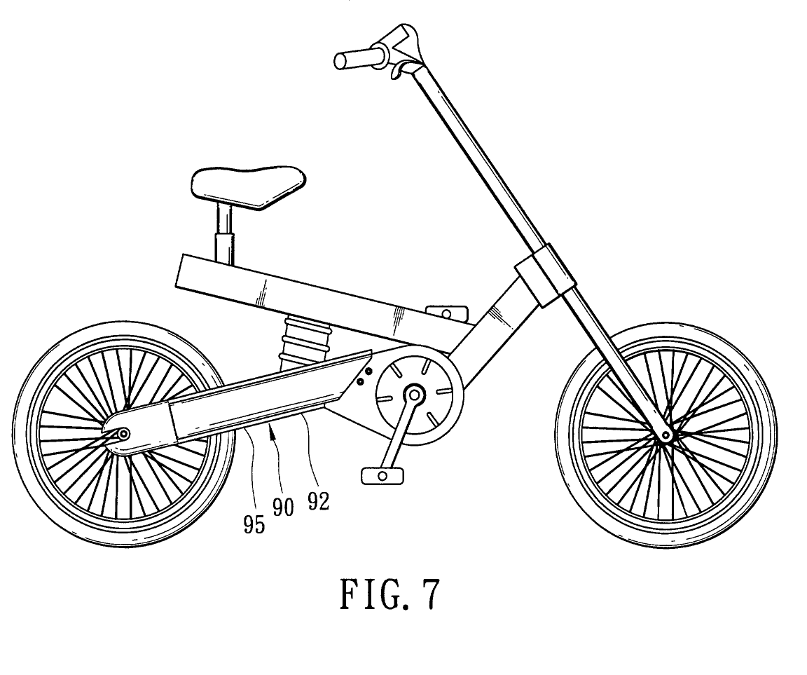

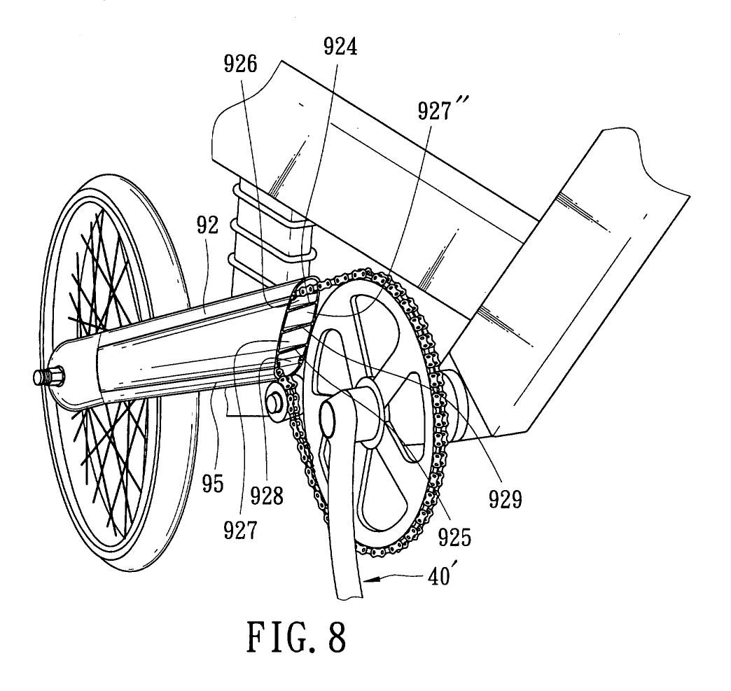

Referring to FIGS. 7 and 8, a modified preferred embodiment of a bicycle according to the present invention is shown to be similar to the previous embodiment in construction. The main difference resides in that the intermediate hollow body 92 further has a third partition 929 extending in the intermediate compartment 927 and parallel to the first and second partitions 924, 925 so as to divide the intermediate compartment 927 into two minor compartments 927″. The peripheral wall of the intermediate hollow body 92 includes a side cover 95 which is detachable so as to expose the upper, lower, and intermediate compartments 926, 928, 927.

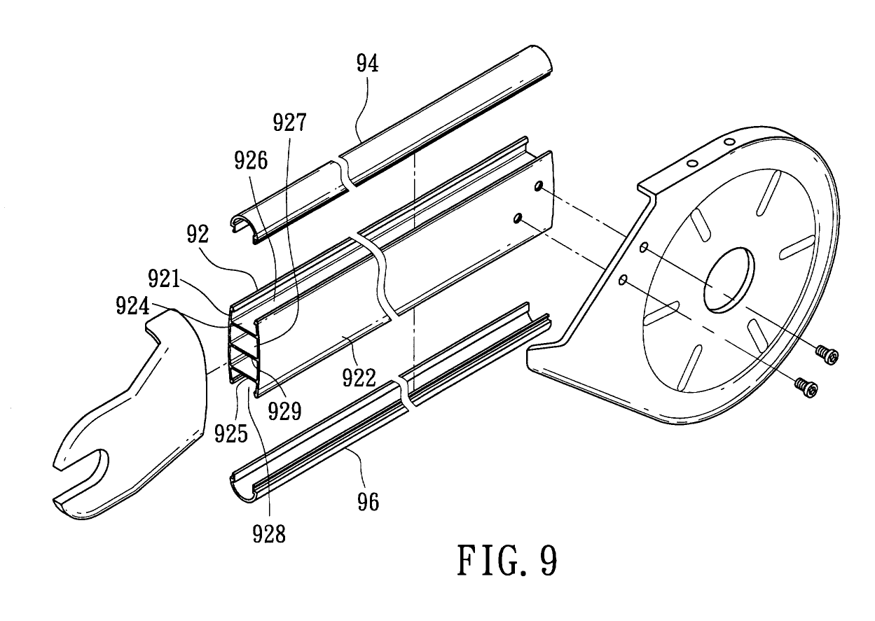

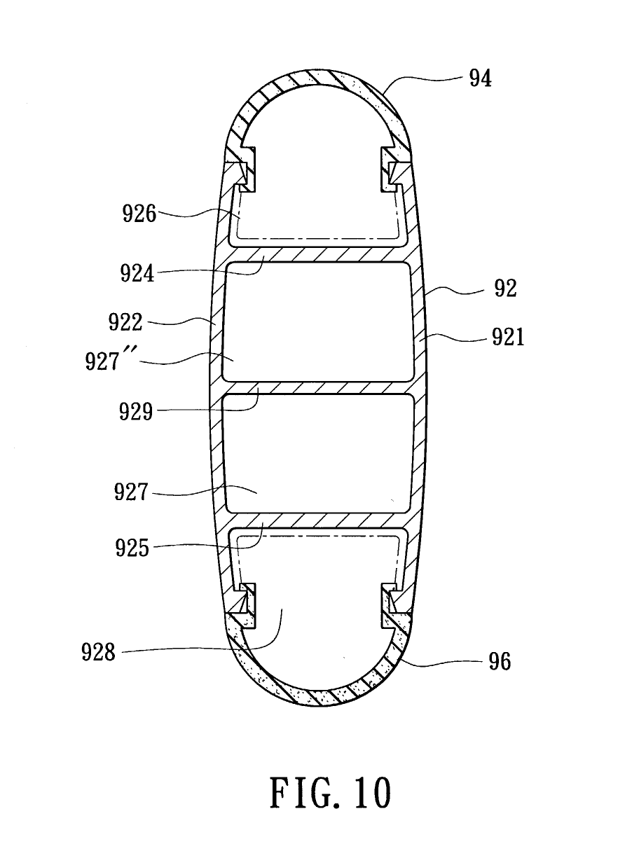

Referring to FIGS. 9 and 10, a modified chain casing is shown to be similar to the previous embodiment in construction. The main difference resides in that the intermediate hollow body 92 includes left and right side plates 921, 922, first, second and third partitions 924, 925, 929 interposed between the left and right side plates 921, 922 to define the upper, lower and intermediate compartments 926, 928, 927, and upper and lower plates 94, 96 detachably mounted to upper and lower ends of the left and right side plates 921, 922 so as to cover the upper and lower compartments 926, 928.

With this invention thus explained, it is apparent that numerous modifications and variations can be made without departing from the scope and spirit of this invention. It is therefore intended that this invention be limited only as indicated in the appended claims.

I claim:

1. A chain casing for a bicycle which includes a chain ring, a crank pedal co-axially connected to the chain ring, an axle disposed rearwardly of the chain ring, a sprocket mounted on the axle, a chain stay extending between the chain ring and the sprocket, and a chain trained on the chain ring and the sprocket, and having upper and lower chain sections, said chain casing comprising:
an intermediate hollow body adapted to be fixed to the chain stay and adapted to extend between the chain ring and the sprocket, said intermediate hollow body having front and rear ends, a peripheral wall extending from said front end to said rear end and defining a receiving space, and a partition extending in said receiving space to divide said receiving space into upper and lower compartments that are adapted to respectively receive the upper and lower chain sections therein; and
a tensioning roller disposed between said front end of said peripheral wall and the chain ring and adapted to be disposed below and in sliding contact with the lower chain section, said tensioning roller being straddled by the lower chain section.

2. The chain casing as defined in claim 1, further comprising a front shield portion detachably fastened to said intermediate hollow body and adapted to cover the chain ring in such a manner as to permit exposure of the crank pedal therefrom, and a rear shield portion detachably fastened to said intermediate hollow body and adapted to cover the sprocket in such a manner as to permit exposure of the axle therefrom.

3. The chain casing as defined in claim 2, further comprising first and second sound-absorbing members mounted respectively in said upper and lower compartments around the upper chain section and the lower chain section of the chain so as to absorb vibrating sound resulting from rotation of the chain ring.

4. A chain casing for a bicycle which includes a chain ring, a crank pedal co-axially connected to the chain ring, an axle disposed rearwardly of the chain ring, a sprocket mounted on the axle, a chain stay extending between the chain ring and the sprocket, and a chain trained on the chain ring and the sprocket, and having upper and lower chain sections, said chain casing comprising:
an intermediate hollow body adapted to be fixed to the chain stay and adapted to extend between the chain ring and the sprocket, said hollow body having front and rear ends, a peripheral wall extending from said front end to said rear end and defining a receiving space, and parallel first and second partitions extending in said receiving space to divide said receiving space into upper and lower compartments that are adapted to receive the upper and lower chain sections respectively, and an intermediate compartment between said upper and lower compartments.

5. The chain casing as defined in claim 4, wherein said intermediate hollow body further includes a third partition extending in said intermediate compartment and parallel to said first and second partitions so as to divide said intermediate compartment into two minor compartments.

6. The chain casing as defined in claim 4, further comprising a tensioning roller disposed between said front end of said peripheral wall and the chain ring and adapted to be disposed below and in sliding contact with the lower chain section, said tensioning roller being straddled by the lower chain section.
